(19) United States
(12) Patent Application Publication
(10) Pub. No.: US 2009/0075611 A1
(43) Pub. Date: Mar. 19, 2009

(54) TUNER THAT CONDUCTS CHANNEL SEARCH, AND DIVERSITY RECEPTION SYSTEM INCLUDING SAID TUNER

(76) Inventor: Yasuhiro WADA, Osaka (JP)

Correspondence Address: BIRCH STEWART KOLASCH & BIRCH, PO BOX 747, FALLS CHURCH, VA, 22040-0747, US

(21) Appl. No.: 12/199,131

(22) Filed: Aug. 27, 2008

(30) Foreign Application Priority Data
Sep. 19, 2007 (JP) 2007-242140(P)

(51) Int. Cl. H04N 5/44; H04B 1/16

(52) U.S. Cl. 455/160.1

(57) ABSTRACT

A tuner includes a first mixer circuit multiplying a first radio signal by a first local oscillation signal corresponding to a selected channel to generate a first baseband signal in a normal mode, and multiplying the first radio signal by a first local oscillation signal corresponding to a channel that is a target of search to generate a first baseband signal in a channel search mode, a second mixer circuit multiplying a second radio signal by a second local oscillation signal corresponding to the selected channel to generate a second baseband signal in the normal mode and the channel search mode, and a combining circuit combining a demodulation signal of the first baseband signal and a demodulation signal of the second baseband signal for output in the normal mode, and to output a demodulation signal of the second baseband signal in the channel search mode.

This nonprovisional application is based on Japanese Patent Application No. 2007-242140 filed on Sep. 19, 2007 with the Japan Patent Office, the entire contents of which are hereby incorporated by reference.

### BACKGROUND OF THE INVENTION

1. Field of the Invention

The present invention relates to a tuner and a diversity reception system including the tuner. Particularly, the present invention relates to a tuner that conducts a channel search, and a diversity reception system including the tuner.

2. Description of the Background Art

Tuners that receive terrestrial digital broadcasting radio waves during transportation are developed. Such a tuner conducts a channel search for concurrently receiving signals of a channel, different from the currently selected channel, during transportation from one service area to another service area. Since the channel information of another service area can be obtained by this channel search, the user can view the broadcasting of the same content continuously without reception disturbance such as instantaneous cut off.

As an example of a configuration of such channel search, Japanese Patent Laying-Open No. 2004-320406, for example, discloses an automatic channel selecting method for terrestrial digital broadcasting. Specifically, a diversity antenna receiver incorporating a double tuner effects reception based on the signals in a better state between the two tuners. When the radio wave is stable, a channel search is conducted using one tuner, and information of all channels in the receiving service area is stored at the receiver. In addition, the broadcasting channel information of an adjacent service area is received at one tuner, and the channel information of the adjacent service area is stored. Thus, seamless reception of broadcasting is allowed when moving to an adjacent service area without having to search for the broadcasting channel of that area.

Japanese Patent Laying-Open No. 05-048984 discloses a TV receiver device for a vehicle. Specifically, the TV receiver device includes two TV tuners, one receiving the desired broadcasting and the other conducting a channel search; collating means for comparing a specific region including a test signal line with respect to the video signals received by the two TV tuners to identify whether they correspond to the same broadcasting or not; reception state comparison means for comparing the reception state of the two TV tuners; and control means for causing one of the two TV tuners to receive a desired broadcasting and the other TV tuner to conduct a channel search for switching the desired broadcasting reception channel to the channel corresponding to the search side when determination is made of being the same broadcast by the collating means and of the better reception state for the TV tuner corresponding to the search side by the reception state comparison means.

However, when an RF (Radio Frequency) signal corresponding to a radio wave of terrestrial digital broadcasting is frequency-converted to an IF (Intermediate Frequency) signal in accordance with the configuration disclosed in the aforementioned publications, signals of two frequencies, differing higher and lower from the frequency of the local oscillation signal by just the IF frequency, will be received. The signal having one of the two higher and lower frequencies is the target RF signal. The signal of the other frequency is an image signal not required. There is a case where the image signal received at one tuner interferes with the RF signal received at the other tuner, leading to degradation in the reception performance.

### SUMMARY OF THE INVENTION

In view of the foregoing, an object of the present invention is to provide a tuner that conducts a channel search and that can prevent degradation in the reception performance, and a diversity reception system including the tuner.

A tuner according to an aspect of the present invention is directed to a tuner having a normal mode and a channel search mode. The tuner includes a first mixer circuit multiplying a first radio signal received at a first antenna by a first local oscillation signal having a frequency corresponding to a selected channel to frequency-convert the first radio signal to a first baseband signal in the normal mode, and multiplying the first radio signal by the first local oscillation signal having a frequency corresponding to a channel that is a target of search to frequency-convert the first radio signal to the first baseband signal in the channel search mode; a second mixer circuit multiplying a second radio signal received at a second antenna by a second local oscillation signal having a frequency corresponding to the selected channel to frequency-convert the second radio signal to a second baseband signal in the normal mode and the channel search mode; a first demodulation circuit demodulating the first baseband signal that is frequency-converted to generate a first demodulation signal; a second demodulation circuit demodulating the second baseband signal that is frequency-converted to generate a second demodulation signal; and a combining circuit receiving the first and second demodulation signals to provide an output that is a combination of the first and second demodulation signals in the normal mode, and to provide an output that is the second demodulation signal in the channel search mode.

Preferably, the tuner further includes a divider dividing the first radio signal; a third mixer circuit multiplying the divided first radio signal by a third local oscillation signal having a frequency corresponding to the selected channel to frequency-convert the divided first radio signal to a third baseband signal in the normal mode and the channel search mode; and a third demodulation circuit demodulating the third baseband signal that is frequency-converted to generate a third demodulation signal. The first mixer circuit multiplies the divided first radio signal by a first local oscillation signal having a frequency corresponding to the selected channel to frequency-convert the first radio signal to the first baseband signal in a normal mode, and multiplies the divided first radio signal by a first local oscillation signal having a frequency corresponding to a channel that is the target of search to frequency-convert the first radio signal to the first baseband signal in the channel search mode. The combining circuit receives the first modulation signal, the second modulation signal, and the third modulation signal to provide an output that is a combination of the first, second and third modulation signals in the normal mode, and to provide an output that is a combination of the second and third demodulation signals in the channel search mode.

Preferably, the tuner farther includes a first voltage control oscillation circuit providing the first local oscillation signal to the first mixer circuit, and a second voltage control oscillation circuit providing a common local oscillation signal to the second mixer circuit and the third mixer circuit as the second local oscillation signal and the third local oscillation signal, respectively.

Preferably, the tuner further includes a first voltage control oscillation circuit generating and providing the first local oscillation signal to the first mixer circuit, a first PLL circuit altering the frequency of the first local oscillation signal by controlling the first voltage control oscillation circuit, a first crystal oscillation circuit providing an oscillation signal to the first PLL circuit, a second voltage control oscillation circuit generating and providing the second local oscillation signal to the second mixer circuit, a second PLL circuit altering the frequency of the second local oscillation signal by controlling the second voltage control oscillation circuit, a third voltage control oscillation circuit generating and providing the third local oscillation signal to the third mixer circuit, a third PLL circuit altering the frequency of the third local oscillation signal by controlling the third voltage control oscillation circuit, and a second crystal oscillation circuit providing a common oscillation signal to the second PLL circuit and the third PLL circuit.

Preferably, the tuner further includes a first RFAGC circuit connected between the first antenna and the first mixer circuit to adjust a level of the first radio signal received at the first antenna, a first baseband AGC circuit connected between the first mixer circuit and the first demodulation circuit to adjust the level of the first baseband signal that is frequency-converted, a first voltage control oscillation circuit generating and providing the first local oscillation signal to the first mixer circuit, a first PLL circuit altering the frequency of the first local oscillation signal by controlling the first voltage control oscillation circuit, a second RFAGC circuit connected between the second antenna and the second mixer circuit to adjust the level of the second radio signal received at the second antenna, a second baseband AGC circuit connected between the second mixer circuit and the second demodulation circuit to adjust the level of the second baseband signal that is frequency-converted, a second voltage control oscillation circuit generating and providing the second local oscillation signal to the second mixer circuit, and a second PLL circuit altering the frequency of the second local oscillation signal by controlling the second voltage control oscillation circuit. The first RFAGC circuit, the first baseband AGC circuit, the first mixer circuit, the first PLL circuit, the second RFAGC circuit, the second baseband AGC circuit, the second mixer circuit, and the second PLL circuit are included in one integrated circuit.

More preferably, the first RFAGC circuit, the first baseband AGC circuit, the first mixer circuit, the first PLL circuit, the first demodulation circuit, the second RFAGC circuit, the second baseband AGC circuit, the second mixer circuit, the second PLL circuit, the second demodulation circuit, and the combining circuit are included in one integrated circuit.

Preferably, the first demodulation circuit, the second demodulation circuit, and the combining circuit are included in one integrated circuit.

Preferably, the tuner further includes a first RFAGC circuit connected between the first antenna and the first mixer circuit to adjust the level of the first radio signal received at the first antenna, a first baseband AGC circuit connected between the first mixer circuit and the first demodulation circuit to adjust the level of the first baseband signal that is frequency-converted, a first voltage control oscillation circuit generating and providing the first local oscillation signal to the first mixer circuit, a first PLL circuit altering the frequency of the first local oscillation signal by controlling the first voltage control oscillation circuit, a second RFAGC circuit connected between the second antenna and the second mixer circuit to adjust the level of the second radio signal received at the second antenna, a second baseband AGC circuit connected between the second mixer circuit and the second demodulation circuit to adjust the level of the second baseband signal that is frequency-converted, a second voltage control oscillation circuit generating and providing the second local oscillation signal to the second mixer circuit, a second PLL circuit altering the frequency of the second local oscillation signal by controlling the second voltage control oscillation circuit, and a casing storing the first RFAGC circuit, the first baseband AGC circuit, the first mixer circuit, the first PLL circuit, the first demodulation circuit, the second RFAGC circuit, the second baseband AGC circuit, the second mixer circuit, the second PLL circuit, the second demodulation circuit, and the combining circuit.

A diversity reception system according to an aspect of the present invention includes a first antenna receiving a first radio signal, a second antenna receiving a second radio signal, a tuner having a normal mode and a channel search mode, and a signal processing unit for decoding a signal received from the tuner. The tuner includes a first mixer circuit multiplying a first radio signal received at a first antenna by a first local oscillation signal having a frequency corresponding to a selected channel to frequency-convert the first radio signal to a first baseband signal in the normal mode, and multiplying the first radio signal by the first local oscillation signal having a frequency corresponding to a channel that is a target of search to frequency-convert the first radio signal to the first baseband signal in the channel search mode; a second mixer circuit multiplying a second radio signal received at a second antenna by a second local oscillation signal having a frequency corresponding to the selected channel to frequency-convert the second radio signal to a second baseband signal in the normal mode and the channel search mode; a first demodulation circuit demodulating the first baseband signal that is frequency-converted to generate a first demodulation signal; a second demodulation circuit demodulating the second baseband signal that is frequency-converted to generate a second demodulation signal; and a combining circuit receiving the first and second demodulation signals to provide an output that is a combination of the first and second demodulation signals to the signal processing unit in the normal mode, and to provide an output that is the second demodulation signal to the signal processing unit in the channel search mode.

According to the present invention, a channel search can be carried out, and degradation in reception performance can be prevented.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a functional block diagram of a tuner according to a first embodiment of the present invention.

FIGS. 2, 3, 4, 5, 6, 7, 8, and 9 represent a configuration of a tuner according to a second, third, fourth, fifth, sixth, seventh, eighth, and ninth embodiment, respectively, of the present invention.

FIG. 10 represents a configuration of a diversity reception system according to a tenth embodiment of the present invention.

### DESCRIPTION OF THE PREFERRED EMBODIMENTS

Embodiments of the present invention will be described hereinafter with reference to the drawings. In the drawings, the same or corresponding elements have the same reference characters allotted, and description thereof will not be repeated.

### First Embodiment

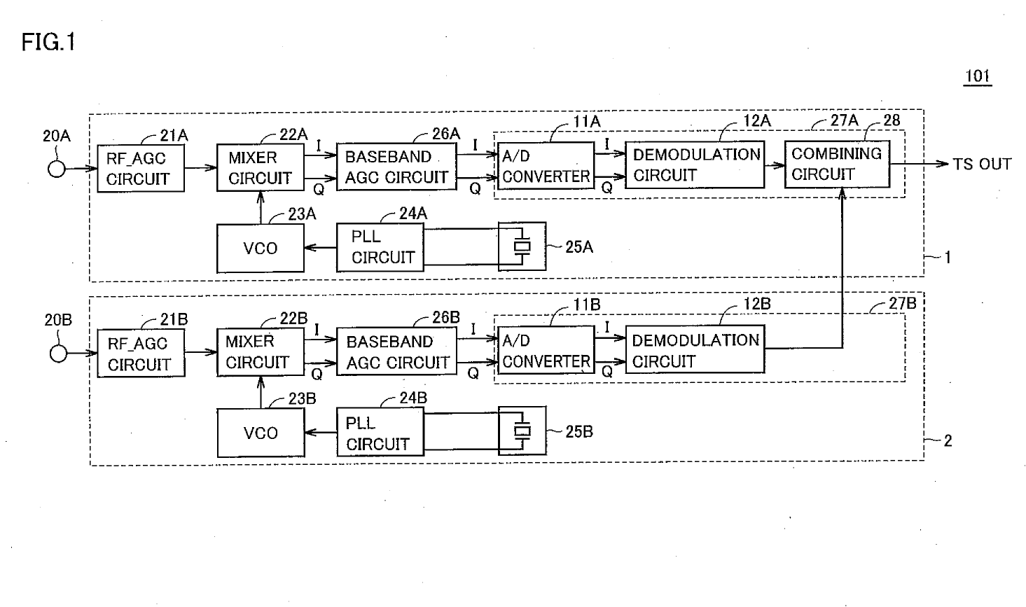

Referring to the functional block diagram of FIG. 1 according to a first embodiment of the present invention, a tuner 101 includes input terminals 20A and 20B, and diversity units 1 and 2. Diversity unit 1 includes an RF-AGC (Auto Gain Control) circuit 21A, a mixer circuit 22A, a VCO (Voltage Controlled Oscillator) 23A, a PLL (Phase Locked Loop) circuit 24A, a crystal oscillation circuit 25A, a baseband AGC circuit 26A, and a demodulation IC (Integrated Circuit) 27A for diversity reception. Diversity unit 2 includes an RF_AGC circuit 21B, a mixer circuit 22B, a VCO 23B, a PLL circuit 24B, a crystal oscillation circuit 25B, a baseband AGC circuit 26B, and a demodulation IC 27B for diversity reception. Diversity-reception demodulation IC 27A includes an A/D (Analog to Digital) converter 11A, a demodulation circuit 12A, and a combining circuit 28. Diversity-reception demodulation IC 27B includes an A/D converter 11B, and a demodulation circuit 12B. Alternatively, a configuration may be implemented in which diversity-reception demodulation IC 27B, not diversity-reception demodulation IC 27A, includes combining circuit 28.

Tuner 101 has a channel search mode in which a channel search is carried out, and a normal mode in which a channel search is not carried out.

Diversity unit 1 effects a reception process of an RF signal to receive the broadcasting corresponding to the selected channel in a normal mode, and effects a reception process of an RF signal to carry out a channel search in a channel search mode.

Diversity unit 2 effects a reception process of an RF signal to receive the broadcasting of the selected channel in a normal mode and a channel search mode.

Input terminals 20A and 20B receive an RF signal (radio signal) from an antenna not shown. An RF signal is a UHF (Ultra High Frequency) signal of 90 MHz-770 MHz, for example.

RF_AGC circuits 21A and 21B adjust the level of the RF signal received from input terminals 20A and 20B, respectively.

Crystal oscillation circuits 25A and 25B drive PLL circuits 24A and 24B by providing an oscillation signal to PLL circuits 24A and 24B, respectively. PLL circuits 24A and 24B alter the oscillation frequency of the local signal (local oscillation signal) based on the oscillation signal received from crystal oscillation circuits 25A and 25B, respectively. Each of VCOs 23A and 23B oscillates under control of PLL circuits 24A and 24B, respectively, to output two local signals differing from each other in phase by π/2.

In a normal mode, PLL circuit 24A controls VCO 23A such that a local signal having a frequency corresponding to the selected channel is provided from VCO 23A to mixer circuit 22A. In a channel search mode, PLL circuit 24A controls VCO 23A such that a local signal having a frequency corresponding to the channel that is the target of search is provided from VCO 23A to mixer circuit 22A.

PLL circuit 24B controls VCO 23B such that a local signal having a frequency corresponding to the selected channel is provided from VCO 23B to mixer circuit 22B in both the normal mode and channel search mode.

Mixer circuit 22A multiplies an RF signal having the level adjusted at RF_AGC circuit 21A by the two local signals from VCO 23A to frequency-convert the RF signal into two baseband signals, which are output as analog signals I and Q. Similarly, mixer circuit 22B multiplies the RF signal having the level adjusted at RF_AGC circuit 21B by the two local signals from VCO 23B to frequency-convert the RF signal into two baseband signals, which are output as analog signals I and Q.

Baseband AGC circuits 26A and 26B adjust the level of analog signals I and Q received from mixer circuits 22A and 22B, respectively.

A/D converters 11A and 11B convert analog signals I and Q having the level adjusted by baseband AGC circuits 26A and 26B into digital signals, which are output as digital signals I and Q.

Demodulation circuits 12A and 12B apply OFDM-demodulation to digital signals I and Q received from A/D converters 11A and 11B, respectively. Demodulation circuits 12A and 12B apply an interpolation process, for example, to the demodulated signals, and provide the signals subjected to the interpolation process to combining circuit 28.

In a normal mode, combining circuit 28 combines the signals subjected to interpolation from demodulation circuits 12A and 12B to output the combined signal as a transport stream signal (hereinafter, also referred to as “TS signal”) to an external source. In a channel search mode, combining circuit 28 does not combine the signals subjected to interpolation, received from demodulation circuits 12A and 12B, and outputs the interpolated signal from demodulation circuit 12B to an external source as a TS signal.

In the case where an apparatus equipped with tuner 101 receives broadcasting while on the run, the service area of broadcasting will change in accordance with the transportation of the apparatus. According to the tuner of the first embodiment in the present invention, the channel information altered in association with the transportation of the apparatus equipped with tuner 101 can be newly obtained by diversity unit 1 of tuner 101 effecting a channel search. Accordingly, even in the case where the apparatus equipped with tuner 101 moves on to another service area, broadcasting of the same content can be received continuously without reception disturbance such as instantaneous cutoff.

In the case where an RF signal corresponding to the radio wave of terrestrial digital broadcasting, for example, is frequency-converted into an IF signal according to the configuration disclosed in the aforementioned publications of Japanese Patent Laying-Open Nos. 2004-320406 and 05-048984, an image signal will be received. The image signal generated at one tuner may interfere with the RF signal received at the other tuner, leading to degradation in the reception performance.

In other words, in the single conversion scheme that frequency-converts an RF signal into an IF signal and an IF signal into a baseband signal, the image signal received at one diversity unit may act as a disturbing signal to the RF signal received at the other diversity unit during a channel search mode in which channels differing between the diversity units are to be selected. The frequency fi of the image disturbing signal is represented by the following equation:

fi=f0+2×fc (1)

where fc is the frequency of the frequency-converted IF signal and f0 is the frequency of the RF signal.

The tuner according to the first embodiment of the present invention employs a direct conversion scheme in which an RF signal is frequency-converted directly into a baseband signal. Namely, equation (1) gives fi=f0, since fc=0. Thus, there will be no image disturbing signal.

Interference on the RF signal and local oscillation signal at the diversity unit by the image signal during a channel search mode can be suppressed. Thus, the reception quality can be rendered favorable even in a channel search mode. The tuner according to the first embodiment of the present invention can conduct a channel search and prevent degradation in the reception performance.

### Second Embodiment

The present embodiment relates to a tuner having a diversity unit added, as compared to the tuner of the first embodiment. The tuner of the present embodiment is similar to the tuner of the first embodiment except for the issues set forth below.

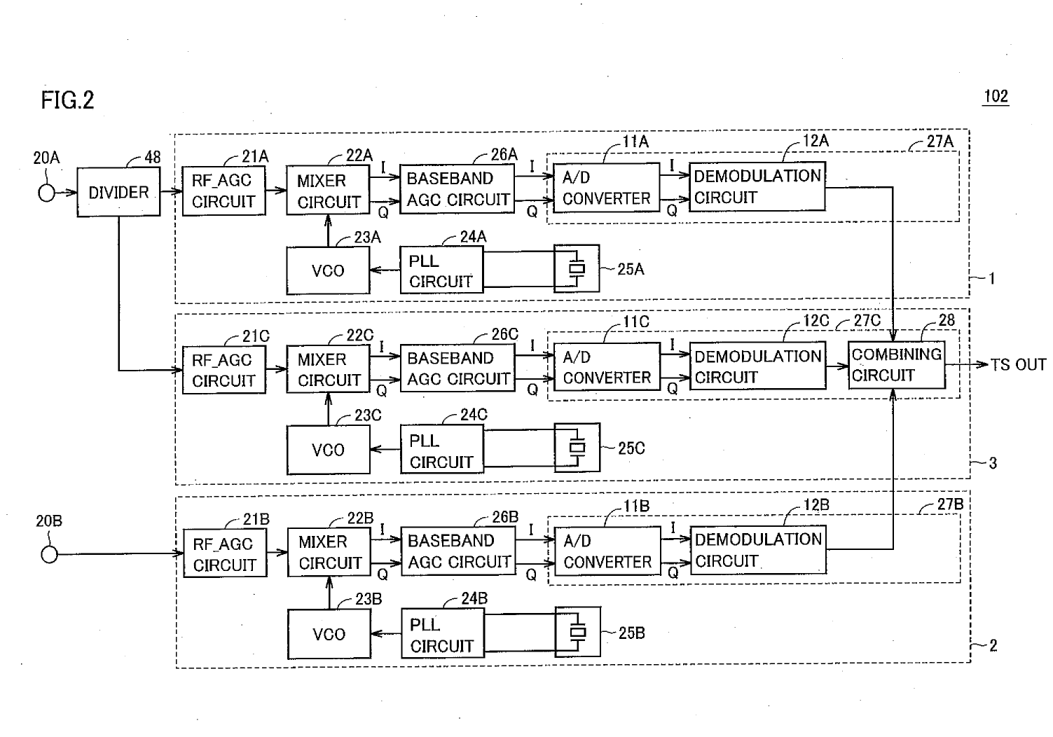

Referring to FIG. 2, a tuner 102 according to the second embodiment of the present invention includes input terminals 20A and 20B, a divider (divider circuit) 48, and diversity units 1, 2 and 3. Diversity unit 3 includes an RF_AGC circuit 21C, a mixer circuit 22C, a VCO 23C, a PLL circuit 24C, a crystal oscillation circuit 25C, a baseband AGC circuit 26C, and a diversity-reception demodulation IC 27C. Diversity-reception demodulation IC 27A includes an A/D converter 11A and a demodulation circuit 12A. Diversity-reception demodulation IC 27B includes an A/D converter 11B, and a demodulation circuit 12B. Diversity-reception demodulation IC 27C includes an A/D converter 11C, a demodulation circuit 12C, and a combining circuit 28.

Diversity unit 3 effects a reception process of an RF signal to receive broadcasting corresponding to the selected channel in a normal mode and a channel search mode.

Divider 48 divides the RF signal received from input terminal 20A for output.

RF_AGC circuit 21A adjusts the level of the RF signal received from divider 48.

At diversity unit 3, RF_AGC circuit 21C adjusts the level of the RF signal received from divider 48.

Crystal oscillation circuit 25C drives PLL circuit 24C by providing an oscillation signal to PLL circuit 24C. PLL circuit 24C alters the oscillation frequency of a local signal (local oscillation signal) based on the oscillation signal received from crystal oscillation circuit 25C. VCO 23C oscillates under control of PLL circuit 24C to output two local signals differing from each other in phase by π/2, for example.

In a normal mode and channel search mode, PLL circuit 24C controls VCO 23C such that a local signal having a frequency corresponding to the selected channel is output from VCO 23C to mixer circuit 22C.

Mixer circuit 22C multiplies the RF signal adjusted in level at RF_AGC circuit 21C by two local signals received from VCO 23C to frequency-convert the RF signal into two baseband signals, which are output as analog signals I and Q.

Baseband AGC circuit 26C adjusts the level of analog signals I and Q received from mixer circuit 22C.

A/D converter 11C converts analog signals I and Q having the level adjusted by baseband AGC circuit 26C into digital signals, which are output as digital signals I and Q.

Demodulation circuit 12C applies OFDM-demodulation to digital signals I and Q received from A/D converter 11C. Demodulation circuit 12C applies an interpolation process, for example, to the demodulated signal, and provides the demodulation signal subjected to interpolation to combining circuit 28.

In a normal mode, combining circuit 28 combines the signals subjected to interpolation, received from each of demodulation circuits 12A, 12B and 12C, to output the combined signal to an external source as a TS signal. In a channel search mode, combining circuit 28 does not employ the interpolation-subjected signal received from demodulation circuit 12A for the combination, and combines only the interpolation-subjected signals received from demodulation circuits 12B and 12C to output the combined signal as a TS signal to an external source.

Since a signal subjected to demodulation and interpolation are combined according to the diversity reception scheme employed by the tuner of the present embodiment, the reception property can be improved as the number of combined signals, i.e. the number of diversity units, becomes higher.

The tuner of the first embodiment has the number of diversity units that receive the broadcasting of the selected channel reduced from two to one in a channel search mode. In the tuner of the second embodiment, divider 48 divides the RF signal received through input terminal 20A and outputs the divided RF signals. Diversity unit 3 effects a reception process of an RF signal to receive broadcasting corresponding to the selected channel in a normal mode and a channel search mode. By this configuration, reduction of the number of diversity units that receive the broadcasting of the selected channel in a channel search mode to one can be prevented. Therefore, favorable reception performance can be realized even when the apparatus equipped with the tuner is on the run at high speed.

The remaining configuration and operation are similar to those of the tuner of the first embodiment. Therefore, detailed description thereof will not be repeated. The tuner of the second embodiment can conduct a channel search, and prevent degradation in the reception performance.

### Third Embodiment

The present embodiment relates to a tuner having a diversity unit added, and some VCO shared, as compared to the tuner of the first embodiment. The tuner of the third embodiment is similar to the tuner of the first embodiment except for the issues set forth below.

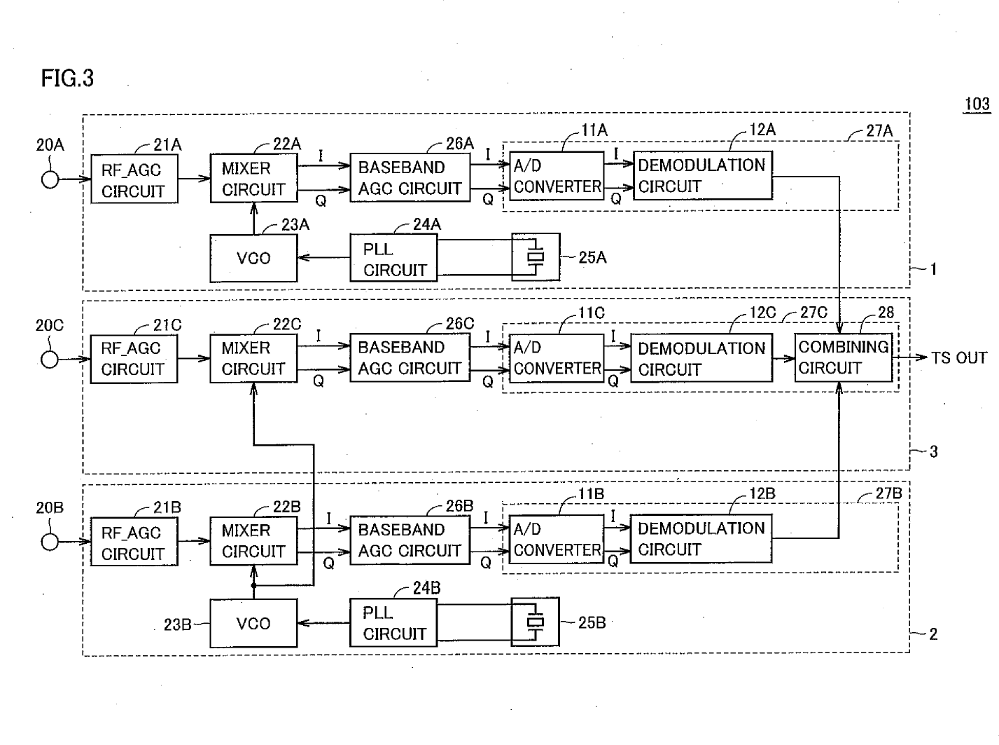

Referring to FIG. 3, a tuner 103 according to a third embodiment of the present invention includes input terminals 20A, 20B and 20C, and diversity units 1, 2 and 3. Diversity unit 3 includes an RF_AGC circuit 21C, a mixer circuit 22C, a baseband AGC circuit 26C, and a diversity-reception demodulation IC 27C. Diversity-reception demodulation IC 27A includes an A/D converter 11A, and a demodulation circuit 12A. Diversity-reception demodulation IC 27B includes an A/D converter 11B and a demodulation circuit 12B. Diversity-reception demodulation IC 27C includes an A/D converter 11C, a demodulation circuit 12C, and a combining circuit 28.

Diversity unit 3 effects a reception process of an RF signal to receive the broadcasting corresponding to the selected channel, in a normal mode and a channel search mode.

At diversity unit 3, RF_AGC circuit 21C adjusts the level of the RF signal received from input terminal 20C.

VCO 23B oscillates under control of PLL circuit 24B to output two local signals differing from each other in phase by π/2 to mixer circuits 22B and 22C,

In a normal mode and a channel search mode, PLL circuit 24B controls VCO 23B such that a local signal having a frequency corresponding to the selected channel is provided from VCO 23B to mixer circuits 22B and 22C.

Mixer circuit 22C multiplies the RF signal having the level adjusted at RF_AGC circuit 21C by the two local signals received from VCO 23B to frequency-convert the RF signal into two baseband signals, which are output as analog signals I and Q.

Baseband AGC circuit 26C adjusts the level of analog signals I and Q received from mixer circuit 22C.

A/D converter 11C converts analog signals I and Q having the level adjusted by baseband AGC circuit 26C into digital signals, which are output as digital signals I and Q.

Demodulation circuit 12C applies OFDM-demodulation to digital signals I and Q received from A/D converter 11C. Demodulation circuit 12C applies an interpolation process, for example, to the demodulated signal, and outputs the demodulated signal subjected to interpolation to combining circuit 28.

In a normal mode, combining circuit 28 combines signals subjected to interpolation, received from each of demodulation circuits 12A, 12B and 12C, and outputs the combined signal to an external source as a TS signal. In a channel search mode, combining circuit 28 does not combine the signal subjected to interpolation, received from demodulation circuit 12A, and combines the signals subjected to interpolation, received from demodulation circuits 12B and 12C, to output the combined signal to an external source as a TS signal.

In accordance with the tuner of the third embodiment, diversity unit 3 effects a reception process of an RF signal to receive the broadcasting corresponding to the selected channel in a normal mode and a channel search mode. By virtue of this configuration, reduction to one in the number of diversity units that receive broadcasting of a selected channel in a channel search mode can be prevented. Favorable reception performance can be realized even when the apparatus equipped with the tuner is on the run at high speed.

In accordance with the configuration in which VCO 23B outputs a common local signal having a frequency corresponding to the selected channel to mixer circuits 22B and 22C in a normal mode and a channel search mode, the size, cost, and power consumption can be reduced, as compared to the tuner of the second embodiment.

The remaining configuration and operation are similar to those of the tuner of the first embodiment. Therefore, detailed description thereof will not be repeated. The tuner of the third embodiment can conduct a channel search, and prevent degradation in the reception performance.

### Fourth Embodiment

The present embodiment relates to a tuner having some VCO shared, as compared to the tuner of the second embodiment. The tuner of the present embodiment is similar to the tuner of the second embodiment except for the issues set forth below.

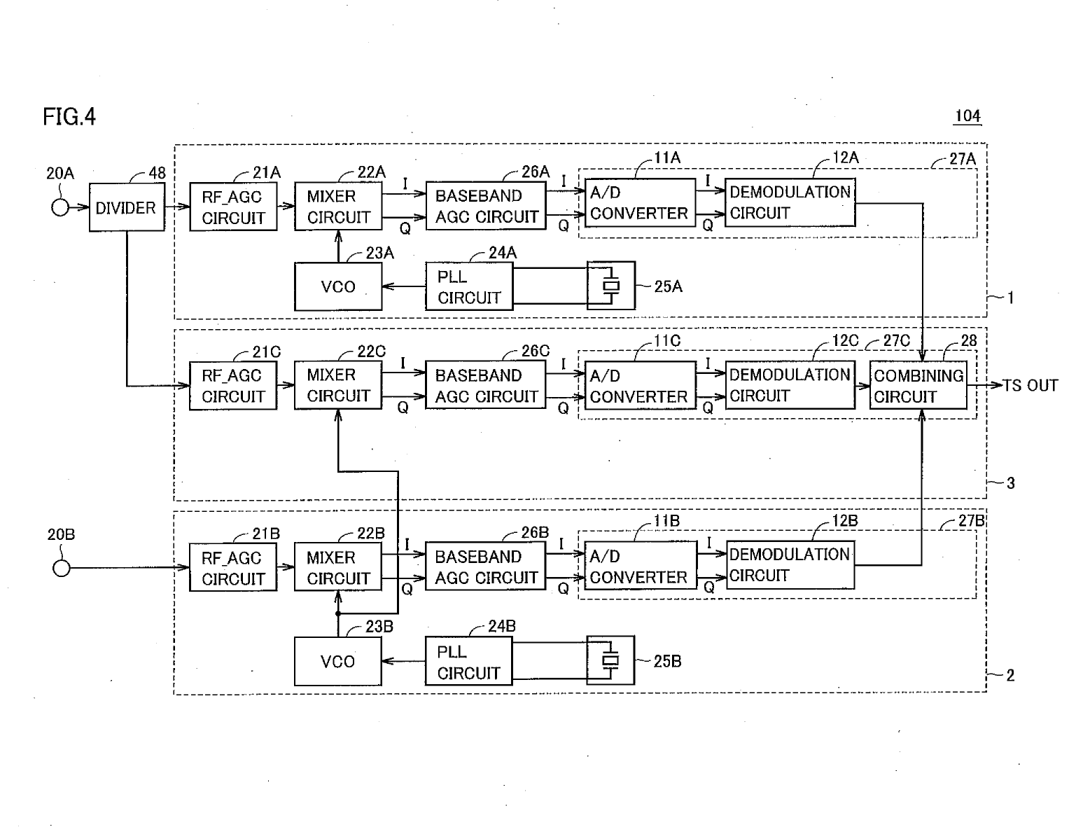

Referring to FIG. 4, a tuner 104 according to a fourth embodiment of the present invention differs from tuner 102 in that diversity unit 3 does not include VCO 23C, PLL circuit 24C, and crystal oscillation circuit 25C.

VCO 23B oscillates under control of PLL circuit 24B to provide two local signals differing from each other in phase by π/2 to mixer circuits 22B and 22C.

In a normal mode and a channel search mode, PLL circuit 24B controls VCO 23B such that a local signal having a frequency corresponding to the selected channel is provided from VCO 23B to mixer circuits 22B and 22C.

Mixer circuit 22C multiplies the RF signal having the level adjusted at RF_AGC circuit 21C by the two local signals received from VCO 23B to frequency-convert the RF signal into two baseband signals, which are output as analog signals I and Q.

According to the configuration in which VCO 23B outputs a common local signal having a frequency corresponding to the selected channel to mixer circuits 22B and 22C in a normal mode and a channel search mode, the size, cost, and power consumption can be reduced, as compared to the tuner of the second embodiment.

The remaining configuration and operation are similar to those of the tuner of the second embodiment. Therefore, detailed description thereof will not be repeated. The tuner of the fourth embodiment can conduct a channel search, and prevent degradation in the reception performance.

### Fifth Embodiment

The present embodiment relates to a tuner having some crystal oscillation circuit shared, as compared to tuner of the first embodiment. The tuner of the fifth embodiment is similar to the tuner of the first embodiment except for the issues set forth below.

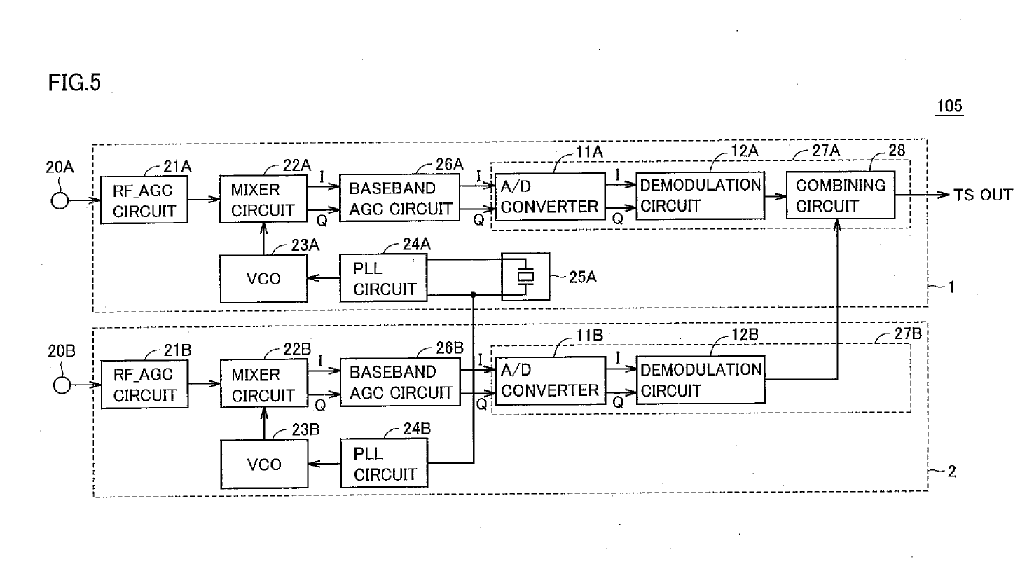

Referring to FIG. 5, a tuner 105 according to the fifth embodiment of the present invention differs from tuner 101 in that diversity unit 2 does not include crystal oscillation circuit 25B.

Crystal oscillation circuit 25A drives PLL circuits 24A and 24B by providing an oscillation signal to PLL circuits 24A and 24B. PLL circuits 24A and 24B alter the oscillation frequency of the local signal (local oscillation signal) based on the oscillation signal received from crystal oscillation circuit 25A. Each of VCOs 23A and 23B oscillates under control of PLL circuits 24A and 24B to output two local signals differing from each other in phase by π/2.

In accordance with the configuration in which crystal oscillation circuit 25A outputs a common oscillation signal to PLL circuits 24A and 24B, the tuner of the fifth embodiment can have the size, cost, and power consumption reduced, as compared to the tuner of the first embodiment.

The remaining configuration and operation are similar to those of the tuner of the first embodiment. Therefore, detailed description thereof will not be repeated. The tuner of the fifth embodiment can conduct a channel search, and prevent degradation in the reception performance.

### Sixth Embodiment

The present embodiment relates to a tuner having some of the circuits integrated, as compared to the tuner of the first embodiment. The tuner of the sixth embodiment is similar to the tuner of the first embodiment except for the issues set forth below.

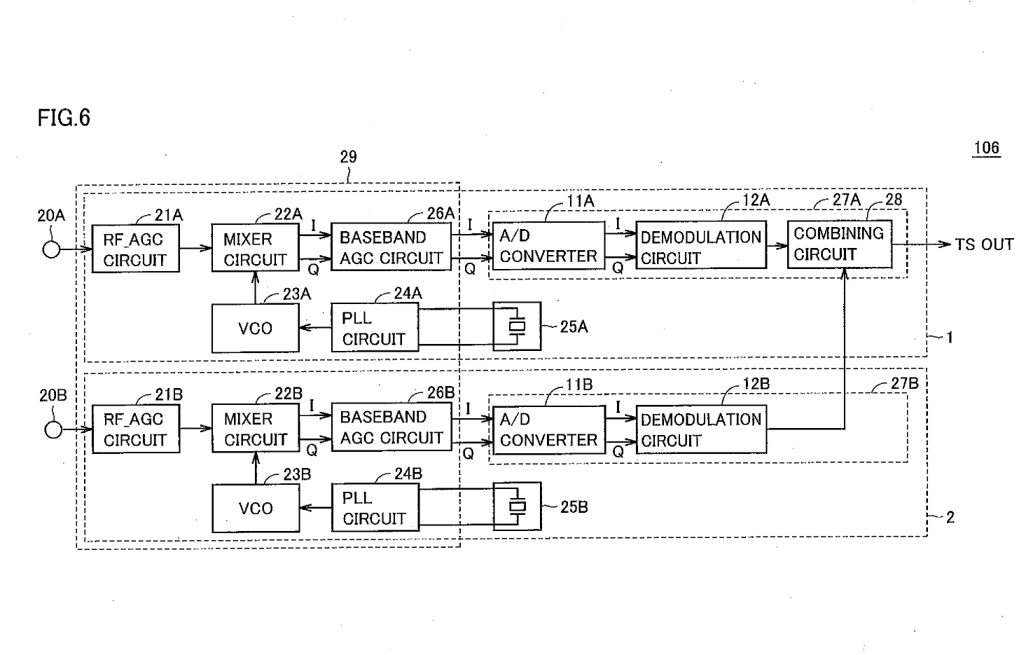

Referring to FIG. 6, a tuner 106 according to a sixth embodiment of the present invention includes an RF_AGC circuit 21A, a mixer circuit 22A, a VCO 23A, a PLL circuit 24A, a baseband AGC circuit 26A, an RF_AGC 21B, a mixer circuit 22B, a VCO 23B, a PLL circuit 24B, and a baseband AGC circuit 26B, all included in an integrated circuit 29.

Since the number of components mounted on the substrate can be reduced by the configuration set forth above, as compared to the tuner of the first embodiment, occurrence of fabrication defects can be suppressed. Furthermore, since the wiring between each of the circuits on the substrate can be reduced, the size can be reduced accordingly.

The remaining configuration and operation are similar to those of the tuner of the first embodiment. Therefore, detailed description thereof will not be repeated. The tuner of the sixth embodiment can conduct a channel search, and prevent degradation in the reception performance.

### Seventh Embodiment

The present embodiment relates to a tuner having some of the circuits integrated, as compared to the tuner of the first embodiment. The tuner of the present embodiment is similar to the tuner of the first embodiment except for the issues set forth below.

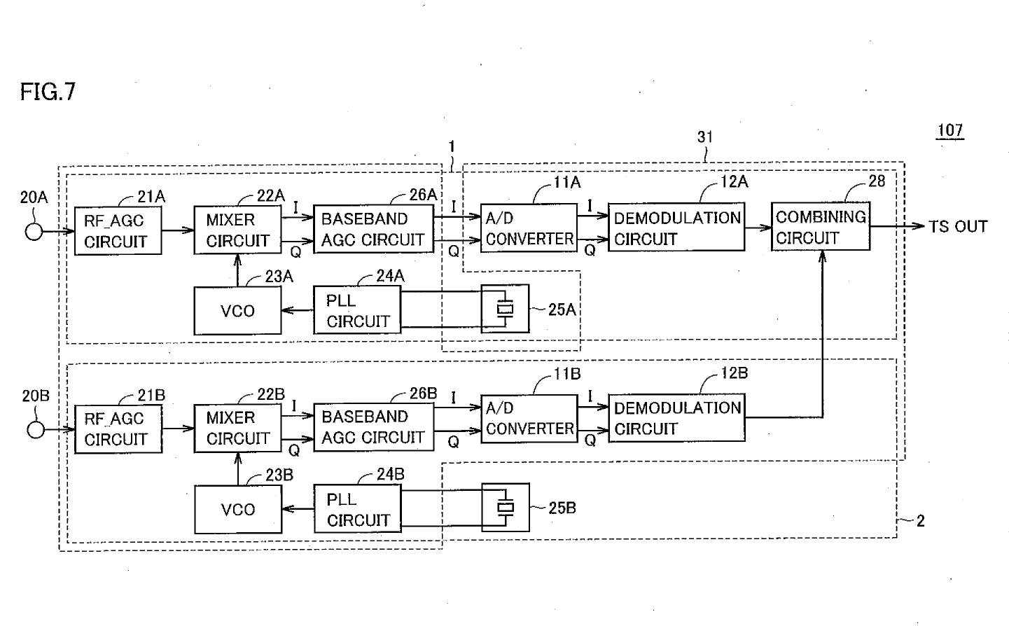

Referring to FIG. 7, a tuner 107 according to a seventh embodiment of the present invention includes an RF_AGC circuit 21A, a mixer circuit 22A, a VCO 23A, a PLL circuit 24A, a baseband AGC circuit 26A, an A/D converter 11A, a demodulation circuit 12A, a combining circuit 28, an RF_AGC circuit 21B, a mixer circuit 22B, a VCO 23B, a PLL circuit 24B, a baseband AGC circuit 26B, an A/D converter 11B, and a demodulation circuit 12B, all included in an integrated circuit 31.

Since the number of components mounted on the substrate can be further reduced by the configuration set forth above, as compared to the tuner of the sixth embodiment, occurrence of fabrication defects can be suppressed. Furthermore, since the wiring between each of the circuits on the substrate can be reduced, the size can be reduced accordingly.

The remaining configuration and operation are similar to those of the tuner of the first embodiment. Therefore, detailed description thereof will not be repeated. The tuner of the seventh embodiment can conduct a channel search, and prevent degradation in the reception performance.

### Eighth Embodiment

The present invention relates to a tuner having some of the circuits integrated, as compared to the tuner of the first embodiment. The tuner of the present embodiment is similar to the tuner of the first embodiment except for the issues set forth below.

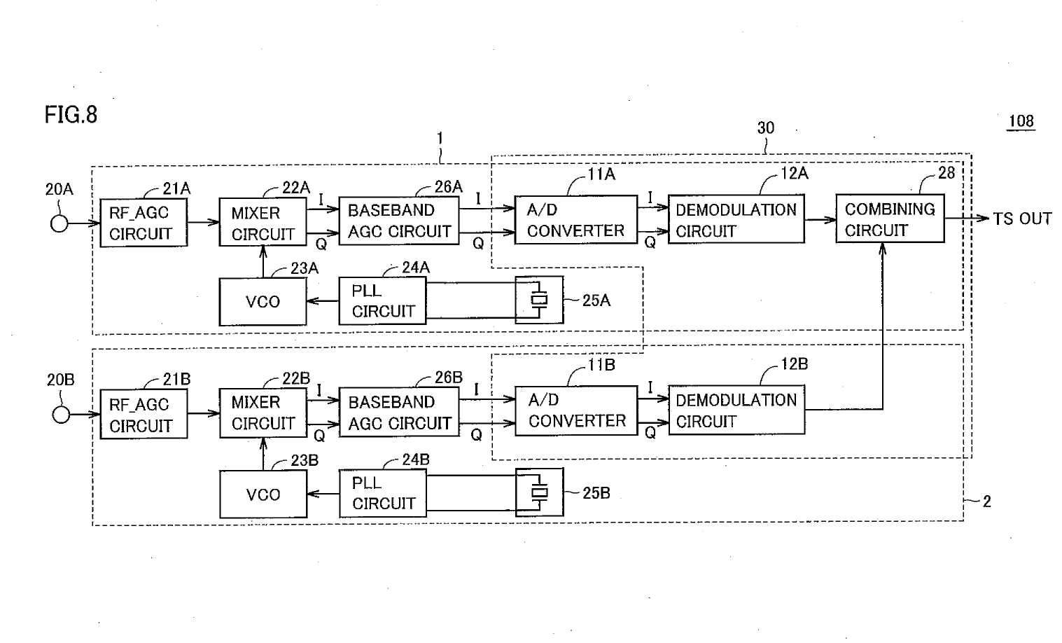

Referring to FIG. 8, a tuner 108 according to an eighth embodiment of the present invention includes an A/D converter 11A, a demodulation circuit 12A, a combining circuit 28, an A/D converter 11B, and a demodulation circuit 12B, all included in an integrated circuit 30.

Since the number of components mounted on the substrate can be further reduced by the configuration set forth above, as compared to the tuner of the first embodiment, occurrence of fabrication defects can be suppressed. Furthermore, since the wiring from combining circuit 28 to demodulation circuits 12A and 12B can be reduced, the size can be reduced accordingly.

The remaining configuration and operation are similar to those of the tuner of the first embodiment. Therefore, detailed description thereof will not be repeated. The tuner of the eight embodiment can conduct a channel search, and prevent degradation in the reception performance.

### Ninth Embodiment

The present invention relates to a tuner with a casing. The tuner of the present embodiment is similar to the tuner of the first embodiment except for the issues set forth below.

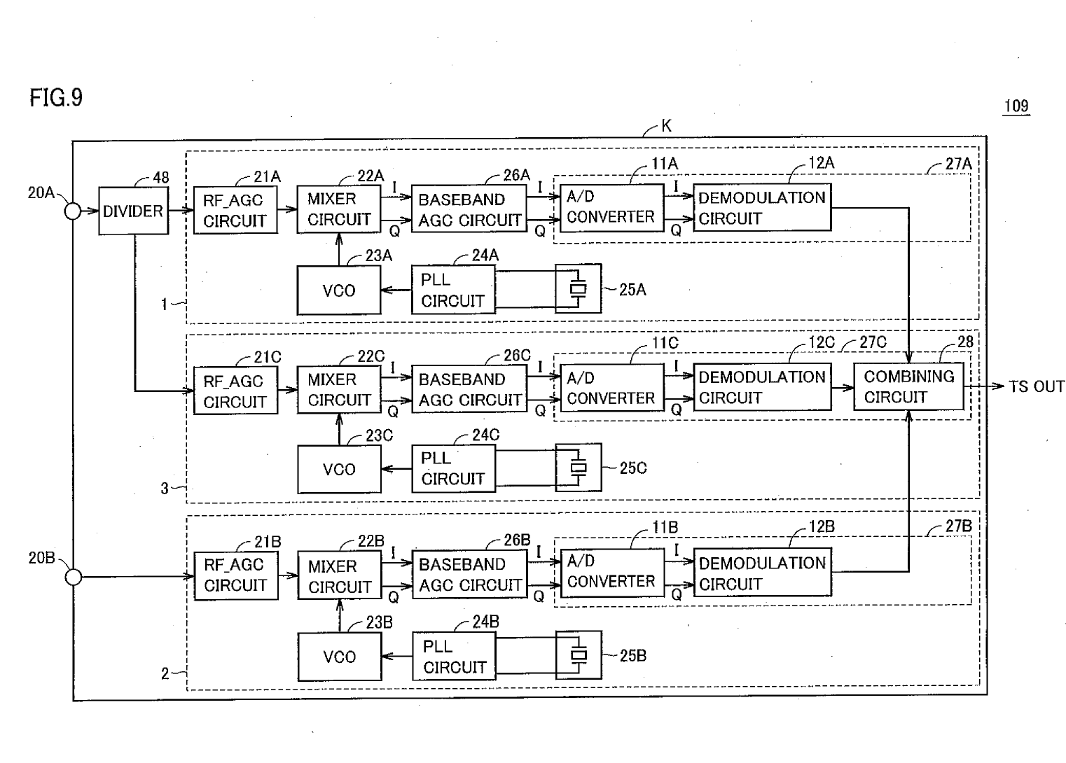

Referring to FIG. 9, a tuner 109 according to a ninth embodiment of the present invention has divider (divider circuit) 48, and diversity units 1, 2 and 3 stored in a casing K. Input terminals 20A and 20B are attached to casing K.

Since the testing procedure of the tuner can be grouped into one by such a configuration, the fabrication cost can be reduced.

The remaining configuration and operation are similar to those of the tuner of the second embodiment. Therefore, detailed description thereof will not be repeated. The tuner of the ninth embodiment can conduct a channel search, and prevent degradation in the reception performance.

### Tenth Embodiment

The present embodiment relates to a diversity reception signal including a tuner.

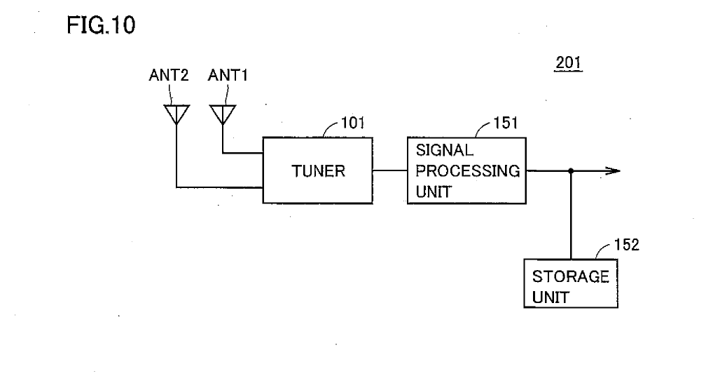

Referring to FIG. 10, a diversity reception system 201 according to the tenth embodiment of the present invention includes antennas ANT1 and ANT2, a tuner 101, a signal processing unit 151, and a storage unit 152.

Antennas ANT1 and ANT2 each receive an RF signal. Tuner 101 effects frequency-conversion of the RF signals received at antennas ANT1 and ANT2 into baseband signals, as well as demodulation, interpolation, and the like, followed by combining the signals subjected to the reception process for output to signal processing unit 151 as a TS signal in order to receive the broadcasting corresponding to the selected channel in a normal mode.

In a channel search mode, tuner 101 effects a reception process on either one of the RF signals received at antennas ANT1 and ANT2 to conduct a channel search, and effects a reception process on the other RF signal in order to receive broadcasting of the selected channel. Tuner 101 outputs the signal generated by the reception process to receive the broadcast corresponding to the selected channel as a TS signal to signal processing unit 151.

Signal processing unit 151 applies an MPEG decoding process, for example, to the TS signal received from tuner 101, and provides the video signal, audio signal, and data obtained by the MPEG decoding process to an external source or to storage unit 152.

Storage unit 152 stores the video signal, audio signal, and data received from signal processing unit 151.

The remaining configuration and operation are similar to those of the tuner of the first embodiment. Therefore, detailed description thereof will not be repeated. According to the diversity reception system of the tenth embodiment of the present invention, a channel search is conducted, and degradation in reception performance can be prevented.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A tuner having a normal mode and a channel search mode, comprising:
a first mixer circuit multiplying a first radio signal received at a first antenna by a first local oscillation signal having a frequency corresponding to a selected channel to frequency-convert said first radio signal into a first baseband signal, in said normal mode, and multiplying said first radio signal by a first local oscillation signal having a frequency corresponding to the channel that is a target of search to frequency-convert said first radio signal into a first baseband signal, in said channel search mode,
a second mixer circuit multiplying a second radio signal received at a second antenna by a second local oscillation signal having a frequency corresponding to said selected channel to frequency-convert said second radio signal into a second baseband signal, in said normal mode and said channel search mode,
a first demodulation circuit demodulating said first baseband signal that is frequency-converted to generate a first demodulation signal,
a second demodulation circuit demodulating said second baseband signal that is frequency-converted to generate a second demodulation signal, and
a combining circuit receiving said first demodulation signal and said second demodulation signal to provide an output that is a combination of said first and second demodulation signals in said normal mode, and to provide an output that is said second demodulation signal in said channel search mode.

2. The tuner according to claim 1, further comprising:
a divider dividing said first radio signal,
a third mixer circuit multiplying said divided first radio signal by a third local oscillation signal having a frequency corresponding to said selected channel to frequency-convert said divided first radio signal into a third baseband signal, in said normal mode and said channel search mode, and
a third demodulation circuit demodulating said third baseband signal that is frequency-converted to generate a third demodulation signal, wherein
said first mixer circuit multiplies said divided first radio signal by a first local oscillation signal having a frequency corresponding to said selected channel to frequency-convert said first radio signal into a first baseband signal, in said normal mode, and multiplying said divided first radio signal by a first local oscillation signal having a frequency corresponding to the channel that is a target of search to frequency-convert said first radio signal into a first baseband signal, in said channel search mode, and
said combining circuit receives said first demodulation signal, said second demodulation signal and said third demodulation signal to provide an output that is a combination of said first, second and third demodulation signals, in said normal mode, and to provide an output that is a combination of said second and third demodulation signals, in said channel search mode.

3. The tuner according to claim 2, further comprising
a first voltage control oscillation circuit providing said first local oscillation signal to said first mixer circuit, and
a second voltage control oscillation circuit providing a common local oscillation signal to said second mixer circuit and said third mixer circuit as said second local oscillation signal and said third local oscillation signal, respectively.

4. The tuner according to claim 2, further comprising:
a first voltage control oscillation circuit generating and providing said first local oscillation signal to said first mixer circuit,
a first PLL circuit controlling said first voltage control oscillation circuit to alter a frequency of said first local oscillation signal,
a first crystal oscillation circuit providing an oscillation signal to said first PLL circuit,
a second voltage control oscillation circuit generating and providing said second local oscillation signal to said second mixer circuit,
a second PLL circuit controlling said second voltage control oscillation circuit to alter the frequency of said second local oscillation signal,
a third voltage control oscillation circuit generating and providing said third local oscillation signal to said third mixer circuit,
a third PLL circuit controlling said third voltage control oscillation circuit to alter the frequency of said third local oscillation signal, and
a second crystal oscillation circuit providing a common oscillation signal to said second PLL circuit and said third PLL circuit.

5. The tuner according to claim 1, further comprising:
a first RFAGC circuit connected between said first antenna and said first mixer circuit to adjust a level of said first radio signal received at said first antenna,
a first baseband AGC circuit connected between said first mixer circuit and said first demodulation circuit to adjust the level of said first baseband signal that is frequency-converted,
a first voltage control oscillation circuit generating and providing said first local oscillation signal to said first mixer circuit,
a first PLL circuit controlling said first voltage control oscillation circuit to alter the frequency of said first local oscillation signal,
a second RFAGC circuit connected between said second antenna and said second mixer circuit to adjust the level of said second radio signal received at said second antenna,
a second baseband AGC circuit connected between said second mixer circuit and said second demodulation circuit to adjust the level of said second baseband signal that is frequency-converted,
a second voltage control oscillation circuit generating and providing said second local oscillation signal to said second mixer circuit, and
a second PLL circuit controlling said second voltage control oscillation circuit to alter the frequency of said second local oscillation signal,
wherein said first RFAGC circuit, said first baseband AGC circuit, said first mixer circuit, said first PLL circuit, said second RFAGC circuit, said second baseband AGC circuit, said second mixer circuit and said second PLL circuit are included in one integrated circuit.

6. The tuner according to claim 5, wherein said first RFAGC circuit, said first baseband AGC circuit, said first mixer circuit, said first PLL circuit, said first demodulation circuit, said second RFAGC circuit, said second baseband AGC circuit, said second mixer circuit, said second PLL circuit, said second demodulation circuit and said combining circuit are included in one integrated circuit.

7. The tuner according to claim 1, wherein said first demodulation circuit, said second demodulation circuit, and said combining circuit are included in one integrated circuit.

8. The tuner according to claim 1, further comprising:
a first RFAGC circuit connected between said first antenna and said first mixer circuit to adjust a level of said first radio signal received at said first antenna,
a first baseband AGC circuit connected between said first mixer circuit and said first demodulation circuit to adjust the level of said first baseband signal that is frequency-converted,
a first voltage control oscillation circuit generating and providing said first local oscillation signal to said first mixer circuit,
a first PLL circuit controlling said first voltage control oscillation circuit to alter the frequency of said first local oscillation signal,
a second RFAGC circuit connected between said second antenna and said second mixer circuit to adjust the level of said second radio signal received at said second antenna,
a second baseband AGC circuit connected between said second mixer circuit and said second demodulation circuit to adjust the level of said second baseband signal that is frequency-converted,
a second voltage control oscillation circuit generating and providing said second local oscillation signal to said second mixer circuit,
a second PLL circuit controlling said second voltage control oscillation circuit to alter the frequency of said second local oscillation signal, and
a casing storing said first RFAGC circuit, said first baseband AGC circuit, said first mixer circuit, said first PLL circuit, said first demodulation circuit, said second RFAGC circuit, said second baseband AGC circuit, said second mixer circuit, said second PLL circuit, said second demodulation circuit and said combining circuit.

9. A diversity reception system comprising:
a first antenna receiving a first radio signal,
a second antenna receiving a second radio signal,
a tuner having a normal mode and a channel search mode, and
a signal processing unit applying a decoding process to a signal received from said tuner,
wherein said tuner comprises
a first mixer circuit multiplying said first radio signal received at said first antenna by a first local oscillation signal having a frequency corresponding to a selected channel to frequency-convert said first radio signal into a first baseband signal, in said normal mode, and multiplying said first radio signal by a first local oscillation signal having a frequency corresponding to a channel that is a target of search to frequency-convert said first radio signal into a first baseband signal, in said channel search mode,
a second mixer circuit multiplying said second radio signal received at said second antenna by a second local oscillation signal having a frequency corresponding to said selected channel to frequency-convert said second radio signal into a second baseband signal, in said normal mode and said channel search mode,
a first demodulation circuit demodulating said first baseband signal that is frequency-converted to generate a first demodulation signal,
a second demodulation circuit demodulating said second baseband signal that is frequency-converted to generate a second demodulation signal, and
a combining circuit receiving said first demodulation signal and said second demodulation signal to provide an output that is a combination of said first and second demodulation signals to said signal processing unit in said normal mode, and to provide an output that is said second demodulation signal to said signal processing unit in said channel search mode.
